(19) United States
(12) Patent Application Publication
(10) Pub. No.: US 2021/0254755 A1
(43) Pub. Date: Aug. 19, 2021

(54) TUB AND SHOWER FIXTURE BLOCK

(71) Applicant: 3D & L, LLC, West Plains, MO (US)

(72) Inventors: DOUGLAS HARRIS, CAPE FAIR, MO (US); LOGAN HARRIS, CAPE FAIR, MO (US)

(21) Appl. No.: 17/181,724

(22) Filed: Feb. 22, 2021

Related U.S. Application Data
(63) Continuation-in-part of application No. 16/406,249, filed on May 8, 2019, now Pat. No. 10,927,979.
(60) Provisional application No. 62/668,607, filed on May 8, 2018.
(60) Provisional application No. 62/823,424, filed on Mar. 25, 2019.

(51) Int. Cl. F16L 3/02

(52) U.S. Cl. CPC F16L 3/02

(57) ABSTRACT

Faucets and other fixtures supported by water supply lines may be subject to undesired movement with respect to a wall as the supporting water lines flex or move. A plumbing fixture provides support and maintains proper positioning to water supply lines for tubs or showers. The body of the plumbing fixture maintains the proper spacing between a water line and a wall surface to provide support or positioning to a faucet or similar fixture attached to the water line. The fixture prevents undesired movement of the faucet with respect to the finished wall surface which can lead to unwanted noise or wear and tear on plumbing systems.

### CROSS-REFERENCE TO RELATED APPLICATIONS

This application is a continuation in part application that claims priority to U.S. patent application Ser. No. 16/406,249 filed May 8, 2019, which claims priority to U.S. Provisional Patent Application Ser. No. 62/668,607 filed May 8, 2018, and U.S. Provisional Patent Application Ser. No. 62/823,424 filed on Mar. 25, 2019, the disclosures of which are incorporated herein by reference.

### BACKGROUND

### Field of the Invention

This disclosure is in the field of plumbing fixtures. More specifically, this disclosure is in the field of brackets for use when installing plumbing supply and drain lines during construction.

### SUMMARY OF THE INVENTION

In various embodiments, the inventive plumbing fixture positions a water supply line in relation to a wall. This holds a fixture such as a tub faucet in proper position with respect to the wall and other elements of the plumbing system.

### BRIEF DESCRIPTION OF THE DRAWINGS

FIG. 1A is a schematic drawing of an embodiment of the fixture.

FIG. 1B is a top plan view of an embodiment of the fixture.

FIG. 2 is a cutaway view of an embodiment of the fixture as installed in a plumbing system.

### DETAILED DESCRIPTION

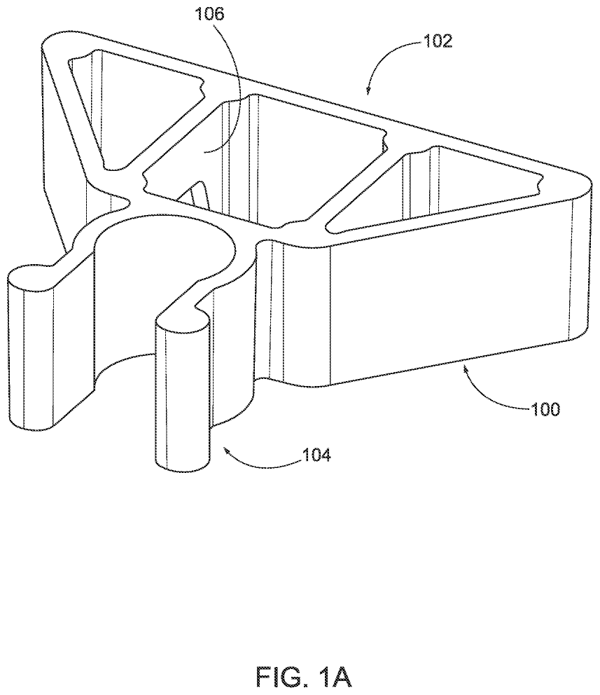

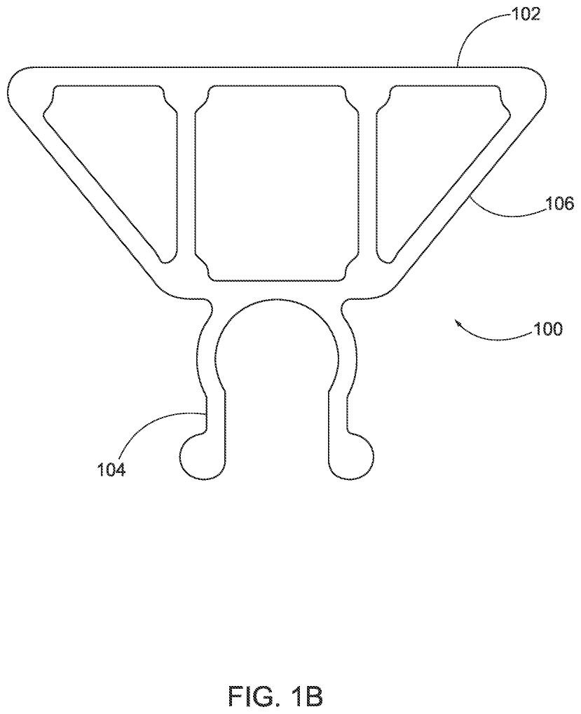

The plumbing fixture described herein provides an improved support and positioning to a water supply line used in plumbing installations such as tub or shower installations. As shown by the embodiment depicted in FIGS. 1A and 1B, the device has a support surface 102 for interacting with the inner surface of a wall, such as the inside surface of sheet rock. It also has a bracket for attachment or connection to a water supply line inside a wall.

The dimensions given herein are an example of a preferred embodiment but are not limiting of the claims herein. In the depicted embodiment the surface 102 is between 2.5 and 3 inches long, and is between 1 and 1.575 inches from the center of feature 104. Similarly, in this embodiment the feature 104 is between 0.5 and 0.75 inches in diameter in the circular cross-section, and has an opening between 0.5 and 0.6 inches. In some embodiments the distance from surface 102 to the distal end of feature 104 is between 2.0 and 2.5 inches. Other embodiments may have other dimensions to allow for larger or smaller water lines, differing distances between the water line and the wall surface. In some embodiments the device may have more than one water line bracket.

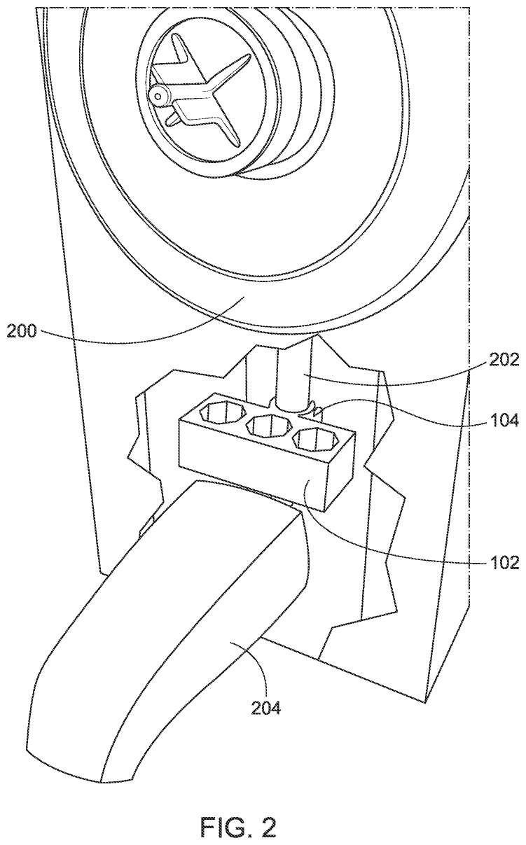

As shown in FIG. 2, a typical tub and shower installation will have a valve assembly 200 that controls the delivery of water to the tub and shower faucets. In a common installation a supply line 202 will extend downwardly from the valve 200, and an elbow or other bend redirects the water line 202 out from the wall cavity through the wall board where a tub faucet 204 is attached to the supply line 202. Without the inventive device installed, the water supply line 202 or the valve 200 may flex, bend, or move with respect to the wall causing the tub faucet attached to the supply line 202 to move away from the outer surface of the wall, and then back toward the outer surface of the wall. The inventive device prevents that movement by holding the water supply line at a desired distance away from an inner surface of the wall.

A typical installation of a plumbing system, such as tub and shower fixtures, may have faucets that extend through a finish wall of the building that are supported largely or entirely by the water supply line to which they are attached. For example, a tub faucet is often supported solely by a supply line 202, which in turn is only supported and held in position by the valve assembly 200. The valve assembly 200 may not be well supported by the structure of the wall or may have flex or play in its components that reduce the rigidity of the support it provides to the tub faucet. This lack of adequate support may allow the faucet 204 to move with respect to the wall and exerting unwanted stress on the valve assembly 200 and the joints in the water supply line 202.

As shown in FIG. 2, an embodiment of the inventive fixture 100 may be installed between the water supply line 202 and an inner surface of the wall. The bracket 104 holds the water line in contact with the body 106 of the fixture 100, while the wall-interacting surface 102 of the fixture 100 touches the inner surface of the wall to prevent the water supply line from moving closer to the wall than the width of the body 106. In some embodiments the body 106 may be attached to the wall or to studs or other components of the wall structure to provide additional support. Other revisions and modifications to the depicted embodiment may still be made within the scope of the claims.

In varying embodiments, the plumbing fixture 100 is positioned between the supply line 202 and an inside surface of the wall. The surface 102 of the fixture 100 positions the fixture 100 with respect to the wall. The water supply line 202 is held in position by a bracket or feature 104 on the fixture 100. The fixture may be a snap on feature as depicted. It could also utilize set screws, zip ties, or clamps of other types to hold the fixture 100 in relation to the water line. The positioning of the block 100 prevents the water supply line 202 from moving back and forth with respect to the wall. The wall-contacting surface 102 may have one or more surfaces, that may be separated such as by legs extending from the body 106. The block may alternatively or additionally be provided with extensions that contact or are attached to other parts of the wall structure such as studs.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A plumbing fixture for positioning a water line in relation to a wall, the plumbing fixture comprising a body having a wall-engaging surface, and a water line bracket attached to the body.

2. The plumbing fixture of claim 1 wherein the water line bracket is disposed apart from the wall-engaging surface to position a water line at a desired position with respect to the wall.

3. The plumbing fixture of claim 1 wherein the body of the plumbing fixture maintains a minimum distance between the water line and the wall.

4. The plumbing fixture of claim 3 wherein the wall-engaging surface contacts an inner surface of the wall.

5. The plumbing fixture of claim 1 wherein the body is affixed to an inner surface of the wall.

6. The plumbing fixture of claim 5 wherein the water line bracket receives the water line and holds it in position with respect to the wall.

7. A plumbing fixture for preventing movement of a tub faucet in relation to a wall, the tub faucet attached to a water supply line, the plumbing fixture comprising a body having a wall-contacting surface, and a bracket attached to the body for receiving the water supply line.

8. The plumbing fixture of claim 7 wherein the body prevents the water supply line from moving toward the wall.

9. The plumbing fixture of claim 7 wherein the body maintains a minimum distance between the water supply line and an inner surface of the wall.

10. The plumbing fixture of claim 7 wherein the body is affixed to the wall and prevents movement of the water supply line with respect to the wall.
